(19) United States
(12) Patent Application Publication
(10) Pub. No.: US 2019/0174791 A1
(43) Pub. Date: Jun. 13, 2019

(54) FREEZE DRIED, READY TO CONSUME FOOD PRODUCTS AND PROCESSES FOR THEIR PREPARATION

(71) Applicant: SINGLESHOT HOLDINGS LLC, Irvine, CA (US)

(72) Inventor: David Kliger, Ramat Gan (IL)

(21) Appl. No.: 16/326,959

(22) PCT Filed: Aug. 17, 2017
(86) PCT No.: PCT/US2017/047256

§ 371 Date: Feb. 21, 2019

Related U.S. Application Data
(60) Provisional application No. 62/377,689, filed on Aug. 22, 2016.
(60) Provisional application No. 62/450,117, filed on Jan. 25, 2017.

(51) Int. Cl. A23F 5/38; A23F 5/40

(52) U.S. Cl. CPC A23F 5/385; A23F 5/26; A23F 5/40

(57) ABSTRACT

The present invention provides a freeze dried solid food product that is ready to be consumed without any further preparations, by directly introducing said product into the mouth. The invention also provides processes for the preparation of said food product.

### TECHNOLOGICAL FIELD

The present invention provides a freeze dried solid food product that is ready to be consumed by directly introducing to the mouth and processes for its preparation.

### BACKGROUND

Some beverages are consumed by subjects for providing hydration as well nutritional elements and other beneficial short term effects. For example, many people drink coffee for the stimulant effect of its caffeine contents. However, in many occasions during a productive working day or while performing other tasks, it is not possible to consume liquid beverages, particularly those that require preparation, for example brewing, boiling, or mixing of the beverage ingredients.

Thus, there is a need for a food product that can provide on the one hand the necessary nutrients and elements of a beverage, but on the other hand does not necessitate the need to prepare said beverage. In particular there is a need for a product that represents a solid form of the beverage that does not require water for its consumption, i.e. ready for eating without any means of preparation. Such a need is solved by the present invention providing a ready to consume food product that comprises said beverage in an edible form. Such a product can be consumed by a subject while performing other tasks.

### GENERAL DESCRIPTION

The present invention provides a food product comprising: (a) at least 0.5% weight of at least one non-dairy beverage component; (b) at least 20% of at least one thickening component; and (c) less than 5% weight of water; wherein said food product is a freeze-dried, ready to be consumed product.

In another one of its aspects the invention provides a process for the preparation of a freeze-dried, ready to be consumed product food product as defined herein above, said process comprising the steps of: (a) providing at least one non-dairy liquid beverage component; (b) preparing a mixture of said non-dairy beverage component and at least one thickening component; and (c) freeze dry said mixture until water content is less than 5% weight of the product; thereby producing said food product.

### DETAILED DESCRIPTION OF EMBODIMENTS

In the first of its aspects the invention provides a food product comprising: (a) at least 0.5% weight of at least one non-dairy beverage component; (b) at least 20% of at least one thickening component; and (c) less than 5% weight of water; wherein said food product is a freeze-dried, ready to be consumed product.

The term “food product” as used herein should be understood to encompass a product that is consumed to provide nutrition to a subject. Said food product of the present invention is in the solid form that is ready to be consumed by directly introducing to the mouth of said subject.

It is further defined that the food product of the present invention is “freeze-dried”, therefore it is achieved by the process of freeze drying resulting in a chewable solid form (see also “Lyophilization: Introduction and Basic Principles” Thomas A. Jennings (Author), http://www.spscientific.com/freeze-drying-lyophilization-basics/, http://www.foodnavigator.com/Science/Freeze-drying-fruit-is-top-technique-for-retaining-nutrients-Study, http://www.watershedfoods.com/our-products/freeze-dried-snacks.html).

Additionally, a food product of the present invention is defined to be a “ready to be consumed product”, thus a product of the present invention does not have to be further prepared in any manner. It does not have to be cooked, rehydrated, steamed, mixed with a liquid (hot or cold), fried, microwaved or any other form of preparation. A product of the present invention is ready to be consumed by a subject as is, without any other additions or preparations. Thus, in some embodiments a food product of the invention is a chewable food product, consumed by eating it by said subject.

The term “at least one non-dairy beverage component” should be understood to encompass a component that is typically a liquid beverage, usually consumed by drinking (hot or cold) that does not include any dairy element. It is noted that a food product of the present invention, thus provides said at least one non-dairy beverage in a chewable solid form as the final product ready to be consumed. Further, it is noted that said at least one non-dairy beverage component is formed into said solid chewable ready to consume food product from a liquid form.

In some embodiments, said at least one non-dairy beverage component could be selected from coffee, tea, fruit juice, soy milk, almond milk, rice milk, chocolate drink, pop-soda, pop-soda syrup, energy drink, energy drink syrup, protein shake, alcoholic beverage and any combinations thereof.

In some embodiments, said at least one non-dairy beverage component is between about 0.5 to about 5% weight of the product. In other embodiments, said at least one non-dairy beverage component is about 0.5%, 0.6%, 0.7%, 0.8%, 0.9%, 1%, 1.5%, 2%, 2.5%, 3%, 3.5%, 4%, 4.5%, 5% weight of the product.

In some embodiments, said at least one non-dairy beverage component is coffee. In some embodiments, said food product of the invention contains caffeine in an amount of at least 0.5% weight. In some embodiments, a food product of the invention contains caffeine in an amount of between 0.5% to 5% by weight.

The term “at least one thickening component” should be understood to encompass any component that is able to increase the viscosity of said at least one non-dairy beverage component without substantially changing its other properties (such as its taste and smell, for example). It is noted that said at least one thickening component is formed from edible elements.

In some embodiments, said at least one thickening component is selected from a monosaccharide, oligosaccharide (for example disaccharides, like sugar), polysaccharide (for example starch, which can be either native, none-native, modified or processed starch and any combinations thereof) or any combinations thereof. In other embodiments, said at least one thickening component is starch. In yet further embodiments, said at least one thickening component is a mixture of starch and sugar. In some embodiments, said at least one thickening component is starch selected from potato starch, tapioca starch, rice starch, corn starch, wheat starch, maze starch, cassava starch, sweet potato starch or any combinations thereof.

In some embodiments, said at least one thickening component is between about 20 to about 70% weight of the product. In some embodiments, said at least one thickening component is about 20%, 25%, 30%, 35%, 40%, 45%, 50%, 55%, 60%, 65%, 70% weight of the product.

The term “less than 5% weight of water” should be understood to relate to the amount of water present in the final food product of the invention. Since the food product of the invention is solid and chewable the amount of hydration in the product to be consumed is reduced to less than 5% by weight of the product.

In some embodiments, a food product of the invention has between about 1% to about 5% of water. In some embodiments, a food product of the invention has between about 1%, 2%, 3%, 4%, 5% weight of the product of water.

In some embodiments, a food product of the invention has a mechanical compressibility of at least 5N/cm²/or Pa⁻¹. In some embodiments, a food product of the invention has a mechanical compressibility in the range of between 5 N/cm² and 20 N/cm².

In some embodiments, a food product of the invention has a density of at least 120 mg/cm³. In some embodiments, a food product of the invention has a density in the range of between 120 mg/cm³ and 500 mg/cm³.

In some embodiments, a food product of the invention further comprises at least one edible oil component. In some embodiments said at least one edible oil component is at least one vegetable oil (for example canola, sunflower oil, or olive oil). In other embodiments, said at least one edible oil component is at least one saturated or unsaturated fatty acid (for example from a vegetable origin or from animal fat origin) and any combinations thereof.

In some embodiments, a food product of the invention further comprises at least one flavoring agent. It should be noted that said flavoring agent relates to any type of edible substance added to a product of the invention (at any step of product preparation) that adds and/or alters and/or intensifies the flavor of a product of the invention through the sense of taste and/or smell. In some embodiments said at least one flavoring agent is a natural flavoring substance (i.e. flavoring substances obtained from plant or animal raw materials, by physical, microbiological or enzymatic processes), a nature-identical flavoring substance (i.e. flavoring substances that are obtained by synthesis or isolated through chemical processes, which are chemically and organoleptically identical to flavoring substances naturally present in products intended for human consumption) or an artificial flavoring substance (i.e. chemically produced flavoring substances that are typically chemically different from the corresponding natural flavoring substance however, in sensory characteristics are the same as natural ones), and any combination thereof.

In some embodiments, said at least one flavoring agent is selected from the group consisting of a sweetening agent (such as a sweetening saccharide, sugar, sugar substitutes), fructose, galactose, flavoring extracts (such as spices and herb flavors, including vanilla, cinnamon, nutmeg, cardamom and so forth; fruit flavors including banana, strawberry, berry, grape, orange, pineapple and so forth) and any combinations thereof.

In some embodiments, a food product of the invention further comprises at least one food supplement or food additive, such as for example at least one nutritional supplement (minerals such as Mg, taurine and so forth), training beneficial supplements (such as for example certain) and so forth.

In some embodiments a food product of the invention is a non-dairy food product, thus it does not contain any dairy component.

In some other embodiments, a food product of the invention further comprising at least one dairy component. Under these embodiments, said at least one dairy component is at least 0.5% weight of said product.

In some other embodiments, a food product of the invention further comprises at least one solid edible component such as chocolate chips, rice puffs, popcorn, ground coffee beans, and a like. Under these embodiments, said at least one solid component is between 5% to 25% weight of said product.

In another one of its aspects the invention provides a food product comprising a combination of at least two different food products as defined hereinabove. Said at least two food products, may be different by any element selected from said none-dairy beverage component, consistency of food product, flavoring agent, dairy component and so forth. In some embodiments, said at least two food products are layered one on top of the other. In some embodiments, said at least two food products are mixed to form a single layer.

The invention further provides a process for the preparation of a solid, ready to be consumed food product as defined herein, said process comprising the steps of: (a) providing at least one non-dairy beverage component; (b) preparing a mixture of said non-dairy beverage component and at least one thickening component; and (c) freeze dry said mixture until water content is less than 5% weight of the product; thereby producing said food product.

In some embodiments a process of the invention further comprises adding at least one edible oil component to said mixture at step (b).

In some embodiments a process of the invention further comprises adding at least one dairy component to said mixture step (b).

In some embodiments a process of the invention further comprises adding at least one solid edible component to said mixture step (b).

In some embodiments a process of the invention said mixture is casted into molds (of predetermined shape and form) prior to said freeze dry step (c).

In some embodiments of a process of the invention, the mixture of step (b) is frozen into droplets prior to said step (c).

In some embodiments, the mixture of step (b) is frozen prior to freeze dry step (c). In some embodiments, said freezing process prior to step (c) is performed by directional freezing of said mixture.

In some further embodiments, a process of the invention further comprises at least one directional freezing step prior to freeze drying in step (c).

In some further embodiments, a process of the invention further comprises of individually quick freezing step prior to freeze drying in step (c).

In some embodiments, said freezing prior to step (c) is performed in an individual quick freeze process.

In some embodiments, a process of the invention further comprises adding at least one emulsifier (such as for example lecithin or any other type of food grade emulsifier or emulsifying agent component) to said mixture in step (b).

In some embodiments, a process of the invention further comprises adding at least one antioxidative agent component to said mixture in step (b).

### Example: Process for the Preparation of a Food Product of the Present Invention

A hot coffee extract was prepared from roasted coffee beans, 0.5 kg were brewed with 2000 ml of water. The extract was then concentrated so that the caffeine level is at least 2.5 mg/ml. 360 ml of the concentrate were mixed with 36 gr of brown sugar, 22 gr of tapioca starch. The mixture was then casted into a mold and freeze to a temperature of −20 C. The frozen mixture was then transferred to a freeze-drying device (“Cool safe superior 95-80” by Labogene), until water level is less than 5% (weight percentage).

1. A food product comprising:
(a) at least 0.5% weight of at least one non-dairy beverage component;
(b) at least 20% of at least one thickening component; and
(c) less than 5% weight of water;
wherein said food product is a freeze-dried, ready to be consumed product.

2. A food product according to claim 1, wherein said at least one non-dairy beverage component is between about 0.5% to about 5% weight of the product.

3. A food product according to claim 1, wherein said at least one thickening component is between about 20% to about 70% weight of the product.

4. A food product according to claim 1, further comprising at least one edible oil component.

5. A food product according to claim 1, further comprising at least one flavoring agent.

6. A food product according to claim 1, wherein said at least one non-dairy beverage component is selected from coffee, tea, fruit juice, soy milk, almond milk, chocolate drink, pop-soda, pop-soda syrup, energy drink, energy drink syrup, protein shake, alcoholic beverage, other beverages and any combinations thereof.

7. A food product according to claim 1, wherein said at least one non-dairy beverage component is coffee, wherein said product contains caffeine in an amount of between 0.5% to 5% by weight.

8. (canceled)

9. (canceled)

10. A food product according to claim 1, wherein said at least one thickening component is selected from a monosaccharide, an oligosaccharide, a polysaccharide and any combinations thereof.

11. A food product according to claim 1, wherein said at least one thickening component is starch.

12. A food product according to claim 1, wherein said at least one thickening component is a mixture of starch and sugar.

13.-23. (canceled)

24. A process for the preparation of a food product as defined in the preceding claims, said process comprising the steps of:
(a) Providing at least one non-dairy beverage component;
(b) Preparing a mixture of said non-dairy food component and at least one thickening component;
(c) Freeze dry said mixture until water content is less than 5% weight of the product;
thereby producing a food product as defined in the preceding claims.

25. A process according to claim 24, further comprising adding at least one edible oil component to said mixture at step (b).

26. A process according to claim 24, further comprising adding at least one dairy component to said mixture step (b).

27. A process according to claim 24, further comprising adding at least one solid edible component to said mixture step (b)

28. A process according to claim 24, wherein said mixture is casted into a mold prior to said freeze dry step (c).

29. A process according to claim 24, wherein the mixture of step (b) is frozen into droplets prior to said step (c).

30. A process according to claim 24, wherein the mixture of step (b) is frozen prior to freeze dry step (c) in a process selected from individual quick freeze process or directional freezing.

31.-32. (canceled)
